(19) United States
(12) Patent Application Publication
(10) Pub. No.: US 2024/0383068 A1
(43) Pub. Date: Nov. 21, 2024

(54) METHOD FOR JOINING TWO COMPONENTS OF A BATTERY BY MEANS OF SCANNER WELDING

(71) Applicant: TRUMPF Laser- und Systemtechnik GmbH, Ditzingen (DE)

(72) Inventors: Tim Hesse, Ditzingen (DE); Nicolai Speker, Pleidelsheim (DE); Patrick Haug, Unteriflingen (DE); Philipp Scheible, Ditzingen/Heimerdingen (DE)

(21) Appl. No.: 18/762,699

(22) Filed: Jul. 3, 2024

Related U.S. Application Data
(63) Continuation of application No. PCT/EP2022/085023, filed on Dec. 8, 2022.

(30) Foreign Application Priority Data
Jan. 5, 2022 (DE) 10 2022 100 230.6

(51) Int. Cl. B23K 26/082; B23K 26/06; B23K 26/26; B23K 26/70; B23K 101/36

(52) U.S. Cl. CPC B23K 26/082; B23K 26/0648; B23K 26/26; B23K 26/705; B23K 2101/36

(57) ABSTRACT

A method for joining two components of a battery includes welding the two components to one another by scanner welding using a processing beam provided by a welding apparatus, and guiding a measurement beam of an OCT sensor system optically coaxially with the processing beam while the welding apparatus is performing the scanner welding. The measurement beam and the processing beam are guided at a substantially matching angle of incidence relative to at least one processing surface of the two components.

### CROSS REFERENCE TO RELATED APPLICATIONS

This application is a continuation of International Application No. PCT/EP2022/085023 (WO 2023/131467 A1), filed on Dec. 8, 2022, and claims benefit to German Patent Application No. DE 10 2022 100 230.6, filed on Jan. 5, 2022. The aforementioned applications are hereby incorporated by reference herein.

### FIELD

Embodiments of the present invention relate to a method of joining two components by scanner welding.

### BACKGROUND

In the prior art, battery covers (so-called can caps) are typically welded onto the so-called battery housings (so-called cans) by means of a laser beam, in order to close the batteries. In the case of this known laser welding method, the laser processing head is moved relative to the component. This ensures orthogonal incidence of the beam at all points of the battery components that are to be welded to one another. This is necessary for a uniform welding depth and a uniform cross section of the weld seam. This results in the formation of a weld seam which runs around the circumference of the battery housing and has a rounding on the upper side of the seam. This rounding ensures that the transition from the battery housing side to the cover surface does not have sharp edges.

Although the laser welding known from the prior art makes it possible to achieve a high weld quality, the relative movement associated with the method between the laser processing head and the battery components means that a relatively complex apparatus structure is necessary. Moreover, it gives rise to a high cycle time owing to the substantial acceleration and deceleration of the laser processing head or of the battery components.

### SUMMARY

Embodiments of the present invention provide a method for joining two components of a battery. The method includes welding the two components to one another by scanner welding using a processing beam provided by a welding apparatus, and guiding a measurement beam of an OCT sensor system optically coaxially with the processing beam while the welding apparatus is performing the scanner welding. The measurement beam and the processing beam are guided at a substantially matching angle of incidence relative to at least one processing surface of the two components.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a processing field containing battery components which are to be joined by means of a method according to embodiments of the invention; and

FIG. 2 shows the implementation of the method according to embodiments of the invention for joining the two components of FIG. 1 by means of a correspondingly configured welding apparatus according to some embodiments.

### DETAILED DESCRIPTION

Embodiments of the invention provide a method which is improved in relation to the method known from the prior art and in particular can ensure a high weld quality together with implementability which is as straightforward and inexpensive as possible.

Accordingly, what is provided is a method for joining two components of a battery, the components being welded to one another by scanner welding by means of a welding apparatus, with a measurement beam of an OCT sensor system being guided optically coaxially with a processing beam of the welding apparatus while the welding apparatus is performing scanner welding, and the measurement beam and the processing beam being guided at a substantially matching angle of incidence relative to at least one processing surface of the two components. In the context of the present application, the wording “optically coaxially” is to be understood to mean that the measurement beam is directed onto the processing surface at least partially via the optical unit of the processing beam. For example, the OCT measurement beam can be deflected by a first scanner device according to a preset scan pattern and then incoupled into a processing optical unit of the processing laser beam, in order to be directed onto the processing surface together with the processing beam, in particular offset from one another. The processing optical unit of the processing beam may comprise a second scanner device, via which the processing beam and the already-deflected measurement beam can be jointly deflected. It is therefore evident that the measurement beam and the processing beam as such do not need to run geometrically coaxially with one another.

The scanner welding in the case of the method according to embodiments of the invention makes it possible for the relative movement necessary in the prior art between the components and the laser processing head in a processing field of the welding apparatus to no longer be necessary. Scanner welding is understood to mean a welding process in which the processing beam is guided via one or more movable mirrors inside a scanner optical unit of the welding apparatus. For this, the welding apparatus, which can be in particular a laser welding apparatus, needs to be fitted with such a scanner optical unit. The processing beam is guided by changing the angles of the one or more mirrors. The result is a processing field in which highly dynamic and precise welding can be performed. Correspondingly, the battery may be processed, or welded, without moving the laser processing head or the components of the battery completely inside the processing field. Correspondingly, complex machine axles on the laser processing head and/or on component holders can be dispensed with or at least not used for a welding operation for a battery, but rather for example only for changing between welding operations on individual batteries. This also makes it possible to enhance the cycle time.

In spite of the scanner welding, it is possible according to embodiments of the invention to achieve a high weld quality by using an OCT (optical coherence tomography) sensor system. The measurement beam generated by the OCT sensor system, or the measurement light, makes it possible to optically monitor the correct welding depth in order to automatically counteract deviations, for instance owing to loss of laser power, contamination of the optical unit and component tolerances. The use of optical coherence tomography as a 3D imaging method which is known per se is advantageous for process control in the case of laser processing. The method involves interferometry with low coherence. In the OCT sensor system, it is possible to use a beam splitter which can split the OCT measurement beam, which can be emitted by a light source, in particular a low-coherence light source, of the OCT sensor system into a reference arm and a probe arm. The light of the probe arm can be incoupled into the scanner optical unit coaxially with the processing beam. The light of the reference arm in turn can be reflected by a fixed mirror, while the light of the probe arm can be reflected by the processing surface. The interference pattern of the two arms can then be analyzed by a spectrometer of the OCT sensor system, which spectrometer provides information about the difference between the optical path length of the probe arm and that of the reference arm. Deflecting the OCT measurement beam at the scanner optical unit or at a scanner, in particular small-field scanner, mounted additionally thereon makes it possible to obtain a depth profile of the workpiece.

The measurement beam and the processing beam are guided at a substantially matching angle of incidence relative to at least one processing surface of the two components. It can be advantageous if the angle of incidence is substantially constant. A substantially constant angle of incidence on sides of the processing beam makes it possible to achieve a high weld quality, because the processing position on the processing surface in the processing field of the welding apparatus is self-contained and a uniform welding depth and a uniform cross section of the weld seam can be achieved. On sides of the measurement beam, a high measurement quality can be ensured, because no measurement value errors can be caused by optical angles and it is possible to accurately control the quality and position. Position-dependent errors do not arise and location-dependent compensations are not necessary. Moreover, the substantially matching angles of incidence of the measurement beam and the processing beam make it possible to compensate for different wavelengths of the processing beam of, for example, approximately 1 μm and of the measurement beam of, for example, <1 μm or >1 μm, which would otherwise lead to different angles of incidence.

Advantageously, the angle of incidence ranges from 80° to 100°, or ranges from 85° to 95°, or the angle of incidence is substantially 90°, it being possible in particular for the angle of incidence to be substantially constant. In other words, the processing beam and the measurement beam can be incident substantially orthogonally on the at least one processing surface and be guided constantly at this angle of incidence during the scanner welding. According to an alternative variant, the angle of incidence ranges from 80° to 100°, or ranges from 85° to 95°, with the angle of incidence not being 90°.

Advantageously, an optically telecentric processing lens is used in the welding apparatus. The optically telecentric processing lens easily and inexpensively enables the substantially matching and substantially constant angles of incidence of the measurement beam and the processing beam. For this, the telecentric processing lens can be placed in the scanner optical unit of the welding apparatus downstream of the one or more mirrors of the scanner optical unit of the processing beam. According to an alternative, preferred variant, a flat-field lens, in particular in the form of a so-called F-theta lens, can be used in the welding apparatus. The flat-field lens can be placed in the scanner optical unit of the welding apparatus downstream of the one or more mirrors of the scanner optical unit of the processing beam. The use of a flat-field lens affords the advantage of a less complex structure and increased cost-effectiveness owing to lower costs. According to this variant, it may be preferred if the processing beam and the measurement beam have a respective wavelength in the same wavelength range, in particular in the range of 1030 nm or 515 nm or 343 nm.

It is also advantageous if the measurement beam locally trails the processing beam on the at least one processing surface. By virtue of the local trailing of the measurement beam, owing to the curvature and during the given relative advancement between the processing beam and the processing surface, the measurement beam can be used to measure the keyhole, or deep vapor capillary, generated during the welding always at the deepest point of the keyhole.

The components may be a battery cover and a battery housing, this being a preferred exemplary application of the method according to embodiments of the invention, in which a high weld quality and measurement quality is necessary to ensure the required gastightness of the battery. The weld seam generated can be generated around the peripheral edge of the battery housing. The battery housing, or the battery can, may for example have a round or prismatic cross section.

It is possible in this case for the two components to be welded to one another with generation of a plain butt joint weld, which has been found to be easy and stable for the field of application of welding battery components.

It is also advantageous if at least one output laser beam is fed into a first end of a multiclad fiber, in particular a 2-in-1 fiber, to generate the processing beam. The multiclad fiber may comprise at least a core fiber and a ring fiber surrounding the core fiber. A first portion of the laser power of the at least one output laser beam may be fed into the core fiber and a second portion of the laser power of the at least one output laser beam may be fed into the ring fiber. Lastly, a second end of the multiclad fiber may be imaged onto the at least one processing surface. Such a design, which can be referred to as an optical cable with an internal fiber and an external fiber, for a fiber laser makes it possible to produce a smooth surface for the weld seam generated. Furthermore, the use of a laser beam having a core portion of high beam quality and a ring portion of lower beam quality—which can be generated by means of a 2-in-1 fiber—is advantageous to the extent that in this way a stable keyhole can be generated during the welding. The good stability of the keyhole in turn has positive effects on the measurability of the welding depth by means of the measurement beam.

It is also advantageous if, in addition to the two components of the battery, at least two further components of at least one further battery are arranged in a processing field of the welding apparatus. Correspondingly, the processing field of the welding apparatus needs to be large enough for there to be space for the respective two components to be welded to one another of a respective battery. The corresponding placement or positioning of the respective two components of a respective battery in the processing field makes it possible to shorten the average cycle time, since the changeover time from one battery to the next within the processing field, or scanning field, is made negligibly small by the scanner optical unit used.

It is also advantageous if, during the scanner welding, a welding depth ranging from 0.3 mm to 2.5 mm, or ranging from 0.4 mm to 2 mm, or ranging from 0.5 mm to 1.5 mm is generated. It has been found that, in the case of a welding depth in this range, it is possible to obtain a weld seam stable enough to keep the battery gastight and at the same time damage to the battery cells in the battery can be prevented.

It is also advantageous if the laser power of the processing beam is regulated in such a way that a welding depth is kept substantially constant. For this, a corresponding regulating apparatus can be provided in the welding apparatus. Substantially constant includes deviations from a mathematically perfectly constant welding depth that are caused by technology or include tolerances. This makes it possible to keep the welding depth constant irrespective of individual influencing variables, with the result that the weld quality can be kept high and damage to the battery cells owing to an excessive welding depth can be prevented.

It is also advantageous if the measurement beam performs a scan leading the processing beam, in particular a TCP (tool center point) laser measurement unit, and this scan is used to adjust a position of a weld seam generated by the processing beam. The lead of the measurement beam may for example range from 1 to 3 mm, for example be 2 mm. In particular, the lateral weld seam position relative to the joint can be regulated. This makes it possible to ensure a correct lateral weld seam position.

It is also advantageous if at least one of the two components is probed with a measurement beam of the OCT sensor system at least at one position, preferably at least at two positions, ideally at least at three or exactly three positions before the scanner welding and a welding trajectory for the scanner welding is adapted to the probed positions. This also makes it possible to ensure a correct lateral weld seam position.

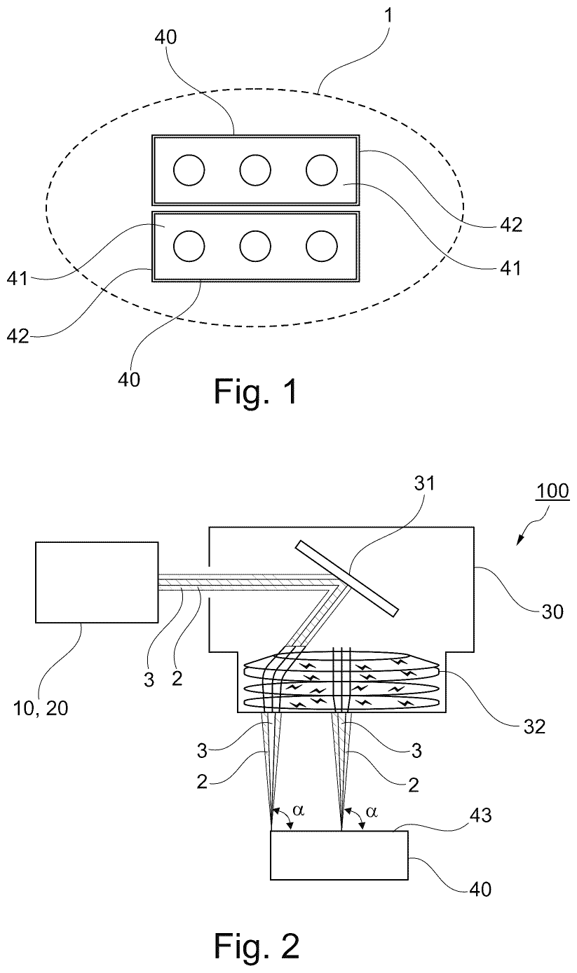

FIG. 1 shows a processing field 1 of the welding apparatus 100 of FIG. 2 containing two respective components 41, 42 in the form of a cover 41 and a battery housing 42 of a respective one of two batteries 40 that are to be finished or closed.

A method according to embodiments of the invention, as shown by way of example in FIG. 2, is used to weld the covers 41 to the battery housings 42, in order to gastightly close the battery 40.

The method according to embodiments of the invention makes use of a welding apparatus 100, in particular a laser welding apparatus, which is fitted with a beam source 10 for generating a processing beam 2, in the present case in the form of a laser beam. The beam source, in the present case in the form of a laser beam, may for example be in the form of a solid-state laser, for example a Nd:YAG laser, a diode laser, a fiber laser or the like. The present example makes use of a fiber laser with a multiclad fiber. In addition to the beam source 10, the welding apparatus 100 has an OCT sensor system 20 for generating a measurement beam 3. In the present case, the beam source 10 and the OCT sensor system 20 are illustrated schematically in the form of a black box, from which the processing beam 2 and the measurement beam 3 emerge and are conducted into a processing head 30 with a scanner optical unit.

In the present case, by way of example, the scanner optical unit of the processing head 30 has a mirror 31 for deflecting the processing beam 2 and the measurement beam 3, but can also have multiple mirrors 31. The two beams 2, 3 are deflected by correspondingly rotating the mirror 31. As a result of the deflection of the two beams 2, 3 imparted in this way, the welding apparatus 100 can cover the entire processing field 1 of FIG. 1 and perform a laser welding and measurement operation therein, which is to say weld both batteries 40 consecutively.

Moreover, the scanner optical unit has an optically telecentric processing lens 32, which is downstream of the mirror 31 in the beam direction of the two beams 2, 3.

During the welding of the two components 41, 42 by scanner welding performed by the welding apparatus 100, the measurement beam 3, as can be seen in FIG. 2, is guided optically coaxially with the processing beam 2 and the measurement beam 3 and the processing beam 2 are guided by means of the telecentric processing lens at a substantially matching and substantially constant angle of incidence a of substantially 90° relative to the processing surface 43 of the battery 40.

In this case, matching means that the two beams 2, 3 have the same angle of incidence a. In this case, constant means that the angle of incidence a remains constant along the welding trajectory or weld seam. Thus, FIG. 2 shows the two beams 2, 3 in a left-hand processing region on the processing surface 43 in the event of the deflection shown in FIG. 2 of the beams 2, 3 by the mirror 31. In a processing region which, by contrast, is in the middle, a further course of the two beams 2, 3 is shown, which can be generated by correspondingly rotating the mirror 31. In relation to the left-hand processing region, or the beams 2, 3 there, it can be seen that there is the same angle of incidence a, which is thus constant and matches for the respective two pairs of beams 2, 3.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for joining two components of a battery, the method comprising:
welding the two components to one another by scanner welding using a processing beam provided by a welding apparatus, and
guiding a measurement beam of an OCT sensor system optically coaxially with the processing beam while the welding apparatus is performing the scanner welding, wherein the measurement beam and the processing beam are guided at a substantially matching angle of incidence relative to at least one processing surface of the two components.

2. The method as claimed in claim 1, wherein the angle of incidence ranges from 80° to 100°.

3. The method as claimed in claim 1, wherein the welding apparatus comprises an optically telecentric processing lens or a flat-field lens.

4. The method as claimed in claim 1, wherein the welding apparatus comprises an F-theta lens.

5. The method as claimed in claim 1, wherein the measurement beam locally trails the processing beam on the at least one processing surface.

6. The method as claimed in claim 1, wherein the two components are a battery cover and a battery housing.

7. The method as claimed in claim 1, wherein the two components are welded to one another by generating a plain butt joint weld.

8. The method as claimed in claim 1, wherein at least one output laser beam is fed into a first end of a multiclad fiber to generate the processing beam, the multiclad fiber comprising at least a core fiber and a ring fiber surrounding the core fiber, wherein a first portion of a laser power of the at least one output laser beam is fed into the core fiber, and a second portion of the laser power of the at least one output laser beam is fed into the ring fiber, and wherein a second end of the multiclad fiber is imaged onto the at least one processing surface.

9. The method as claimed in claim 1, wherein at least two further components of at least one further battery are arranged in a processing field of the welding apparatus.

10. The method as claimed in claim 1, wherein a welding depth ranging from 0.3 mm to 2.5 mm is generated during the scanner welding.

11. The method as claimed in claim 1, wherein a laser power of the processing beam is regulated in such a way that a welding depth is kept substantially constant.

12. The method as claimed in claim 1, wherein the measurement beam performs a scan leading the processing beam, the scan being used to adjust a position of a weld seam generated by the processing beam.

13. The method as claimed in claim 1, wherein at least one of the two components is probed with the measurement beam of the OCT sensor system at least at one position before the scanner welding, and a welding trajectory for the scanner welding is adapted to the at least one probed position.
